(19) United States
(12) Patent Application Publication
(10) Pub. No.: US 2010/0317433 A1
(43) Pub. Date: Dec. 16, 2010

(54) WAGERING GAME MACHINE WITH USER INTERFACE PREFERENCES

(75) Inventors: Marwan Ansari, Plainfield, IL (US); Craig J. Sylla, Round Lake, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc., Waukegan, IL (US)

(21) Appl. No.: 12/866,194

(22) PCT Filed: Feb. 3, 2009
(86) PCT No.: PCT/US2009/000667

§ 371 Date: Aug. 4, 2010

Related U.S. Application Data
(60) Provisional application No. 61/026,018, filed on Feb. 4, 2008.

(51) Int. Cl. A63F 13/00; A63F 9/24

(52) U.S. Cl. 463/30; 463/43

(57) ABSTRACT

Systems and methods present images for elements of a wagering game in accordance with user preferences. The size, location, aspect ratio, scaling input methodology, scaling display methodology and user interfaces present on a primary or secondary display may be controlled using the user preferences. User preferences in conjunction with wagering game events may be used to control display characteristics of elements displayed on a primary or secondary display of a wagering game machine.

### RELATED APPLICATION

This patent application claims the priority benefit of U.S. Provisional Patent Application Ser. No. 61/026,018 filed Feb. 4, 2008 and entitled “WAGERING GAME MACHINE WITH USER INTERFACE PREFERENCES”, the content of which is incorporated herein by reference in its entirety.

### FIELD

The embodiments relate generally to wagering game machines and more particularly to wagering game machines providing a user interface according to a user's preference information.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright© 2008, WMS Gaming Inc. All Rights Reserved.

### BACKGROUND

Wagering game machine makers continually provide new and entertaining games. One way of increasing entertainment value associated with casino-style wagering games (e.g., video slots, video poker, video black jack, and the like) includes offering a variety of base games and bonus events. However, despite the variety of base games and bonus events, players often lose interest in repetitive wagering game content. In order to maintain player interest, wagering game machine makers frequently update wagering game content with new game themes, game settings, bonus events, game software, and other electronic data. Further, entertainment value may be increased by providing an enhanced visual game play experience. Additionally, wagering games may be presented on a variety of differing wagering game platforms, each having different display characteristics.

### BRIEF DESCRIPTION OF THE DRAWINGS

FIG. 1 is a perspective view of a wagering game machine, according to example embodiments of the invention.

FIG. 2 is a perspective view of a portable wagering game machine according to an example embodiment.

FIG. 3 is a block diagram of an architecture, including a control system, for a wagering game machine according to an example embodiment.

FIG. 4 is a block diagram of a software architecture for a wagering game machine according to an example embodiment.

FIG. 5 is a block diagram of a networked system of wagering game machines and servers according to example embodiments.

FIG. 6 is a flowchart illustrating methods for resizing graphical images for a wagering game machine according to example embodiments.

FIGS. 7A and 7B illustrate example interface layouts according to embodiments of the invention.

FIGS. 8A and 8B are example portal interfaces according to embodiments of the invention.

FIG. 9 illustrates scaling operations of embodiments of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

In general, the system and method embodiments described below provide for the presentation of a wagering game and user interface elements such as help screens, pay tables, input interfaces and portal interfaces according to user preference information. The description of the various embodiments is to be construed as exemplary only and does not describe every possible instance of the invention. Numerous alternatives could be implemented, using combinations of current or future technologies, which would still fall within the scope of the claims. The following detailed description is, therefore, not to be taken in a limiting sense, and the scope of the present invention is defined only by the appended claims.

### Example Wagering Game Machine

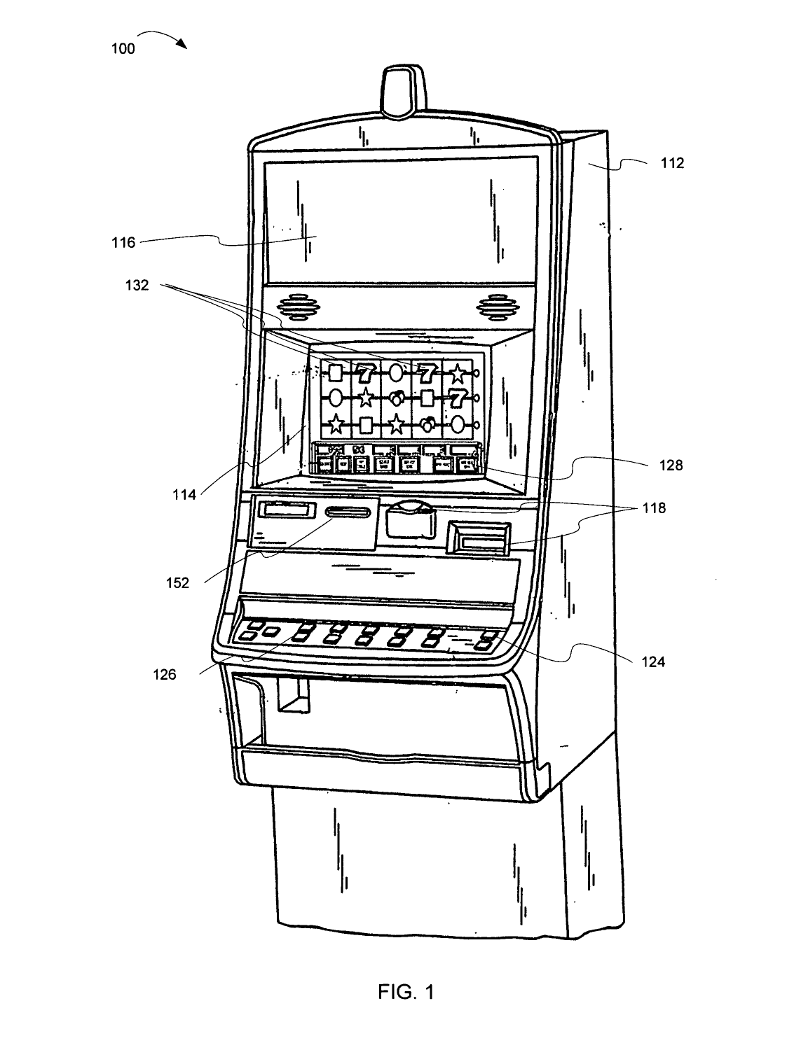

FIG. 1 is a perspective view of a wagering game machine, according to example embodiments of the invention. Referring to FIG. 1, a wagering game machine 100 is used in gaming establishments, such as casinos. According to embodiments, the wagering game machine 100 can be any type of wagering game machine and can have varying structures and methods of operation. For example, the wagering game machine 100 can be an electromechanical wagering game machine configured to play mechanical slots, or it can be an electronic wagering game machine configured to play video casino games, such as blackjack, slots, keno, poker, blackjack, roulette, etc.

The wagering game machine 100 comprises a housing 112 and includes input devices, including value input devices 118 and a player input device 124. For output, the wagering game machine 100 includes a primary display 114 for displaying information about a basic wagering game. The primary display 114 can also display information about a bonus wagering game and a progressive wagering game. The wagering game machine 100 also includes a secondary display 116 for displaying wagering game events, wagering game outcomes, and/or signage information. While some components of the wagering game machine 100 are described herein, numerous other elements can exist and can be used in any number or combination to create varying forms of the wagering game machine 100.

The value input devices 118 can take any suitable form and can be located on the front of the housing 112. The value input devices 118 can receive currency and/or credits inserted by a player. The value input devices 118 can include coin acceptors for receiving coin currency and bill acceptors for receiving paper currency. Furthermore, the value input devices 118 can include ticket readers or barcode scanners for reading information stored on vouchers, cards, or other tangible portable storage devices. The vouchers or cards can authorize access to central accounts, which can transfer money to the wagering game machine 100.

The player input device 124 comprises a plurality of push buttons on a button panel 126 for operating the wagering game machine 100. In addition, or alternatively, the player input device 124 can comprise a touch screen 128 mounted over the primary display 114 and/or secondary display 116.

The various components of the wagering game machine 100 can be connected directly to, or contained within, the housing 112. Alternatively, some of the wagering game machine's components can be located outside of the housing 112, while being communicatively coupled with the wagering game machine 100 using any suitable wired or wireless communication technology.

The operation of the basic wagering game can be displayed to the player on the primary display 114. The primary display 114 can also display a bonus game associated with the basic wagering game. The primary display 114 can include a cathode ray tube (CRT), a high resolution liquid crystal display (LCD), a plasma display, light emitting diodes (LEDs), or any other type of display suitable for use in the wagering game machine 100. Alternatively, the primary display 114 can include a number of mechanical reels to display the outcome. In FIG. 1, the wagering game machine 100 is an “upright” version in which the primary display 114 is oriented vertically relative to the player. Alternatively, the wagering game machine can be a “slant-top” version in which the primary display 114 is slanted at about a thirty-degree angle toward the player of the wagering game machine 100. In yet another embodiment, the wagering game machine 100 can exhibit any suitable form factor, such as a free standing model, bartop model, mobile handheld model, or workstation console model. Further, in some embodiments, the wagering game machine 100 may be include an attached chair assembly, and may include audio speakers designed to provide an enhanced audio environment. For example, a “surround sound” system may be included as part of the wagering game machine and may be integrated with the attached chair.

A player begins playing a basic wagering game by making a wager via the value input device 118. The player can initiate play by using the player input device's buttons or touch screen 128. The basic game can include arranging a plurality of symbols along a payline 132, which indicates one or more outcomes of the basic game. Such outcomes can be randomly selected in response to player input. At least one of the outcomes, which can include any variation or combination of symbols, can trigger a bonus game.

In some embodiments, the wagering game machine 100 can also include an information reader 152, which can include a card reader, ticket reader, bar code scanner, RFID transceiver, or computer readable storage medium interface. In some embodiments, the information reader 152 can be used to award complimentary services, restore game assets, track player habits, etc.

### Example Portable Wagering Game Machine

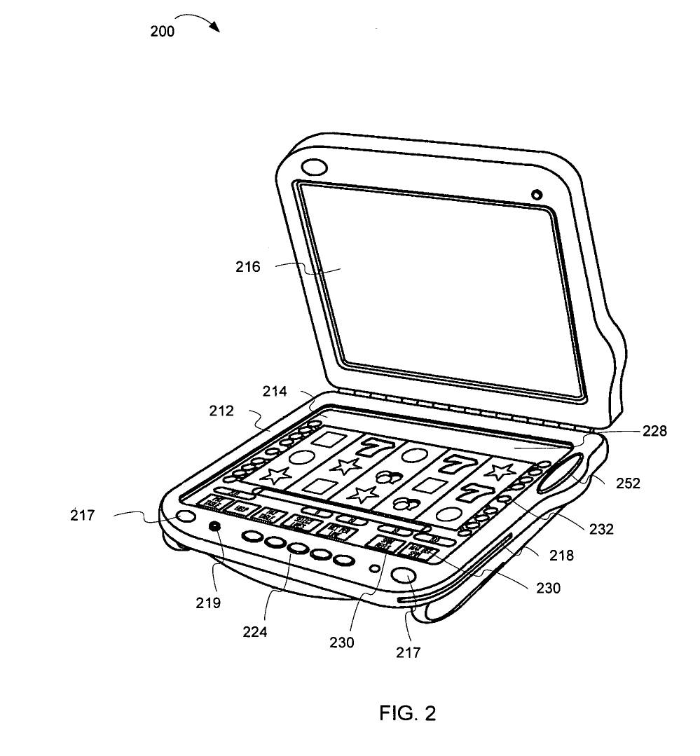

FIG. 2 shows an example embodiment of a portable wagering game machine 200. The portable wagering game machine 200 can include any suitable electronic handheld or mobile device configured to play a video casino game such as blackjack, slots, keno, poker, blackjack, and roulette. The wagering game machine 200 comprises a housing 212 and includes input devices, including a value input device 218 and a player input device 224. For output, the wagering game machine 200 includes a primary display 214, and may include a secondary display 216, one or more speakers 217, one or more player-accessible ports 219 (e.g., an audio output jack for headphones, a video headset jack, etc.), and other conventional I/O devices and ports, which may or may not be player-accessible. In the embodiment depicted in FIG. 2, the wagering game machine 200 includes a secondary display 216 that is rotatable relative to the primary display 214. The optional secondary display 216 can be fixed, movable, and/or detachable/attachable relative to the primary display 214. Either the primary display 214 and/or secondary display 216 can be configured to display any aspect of a non-wagering game, wagering game, secondary game, bonus game, progressive wagering game, group game, shared-experience game or event, game event, game outcome, scrolling information, text messaging, emails, alerts or announcements, broadcast information, subscription information, and wagering game machine status.

The player-accessible value input device 218 can comprise, for example, a slot located on the front, side, or top of the casing 212 configured to receive credit from a stored-value card (e.g., casino card, smart card, debit card, credit card, etc.) inserted by a player. The player-accessible value input device 218 can also comprise a sensor (e.g., an RF sensor) configured to sense a signal (e.g., an RF signal) output by a transmitter (e.g., an RF transmitter) carried by a player. The player-accessible value input device 218 can also or alternatively include a ticket reader, or barcode scanner, for reading information stored on a credit ticket, a card, or other tangible portable credit or funds storage device. The credit ticket or card can also authorize access to a central account, which can transfer monetary value to the wagering game machine 200.

Still other player-accessible value input devices 218 can require the use of touch keys 230 on the touch-screen display (e.g., primary display 214 and/or secondary display 216) or player input devices 224. Upon entry of player identification information and, preferably, secondary authorization information (e.g., a password, PIN number, stored value card number, predefined key sequences, etc.), the player can be permitted to access a player's account. As one potential optional security feature, the wagering game machine 200 can be configured to permit a player to only access an account the player has specifically set up for the wagering game machine 200. Other conventional security features can also be utilized to, for example, prevent unauthorized access to a player's account, to minimize an impact of any unauthorized access to a player's account, or to prevent unauthorized access to any personal information or funds temporarily stored on the wagering game machine 200.

The player-accessible value input device 218 can itself comprise or utilize a biometric player information reader which permits the player to access available funds on a player's account, either alone or in combination with another of the aforementioned player-accessible value input devices 218. In an embodiment wherein the player-accessible value input device 218 comprises a biometric player information reader, transactions such as an input of value to the wagering game machine 210, a transfer of value from one player account or source to an account associated with the wagering game machine 200, or the execution of another transaction, for example, could all be authorized by a biometric reading, which could comprise a plurality of biometric readings, from the biometric device.

Alternatively, to enhance security, a transaction can be optionally enabled only by a two-step process in which a secondary source confirms the identity indicated by a primary source. For example, a player-accessible value input device 218 comprising a biometric player information reader can require a confirmatory entry from another biometric player information reader 252, or from another source, such as a credit card, debit card, player ID card, fob key, PIN number, password, hotel room key, etc. Thus, a transaction can be enabled by, for example, a combination of the personal identification input (e.g., biometric input) with a secret PIN number, or a combination of a biometric input with an authentication fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 218 can be provided remotely from the wagering game machine 200.

The player input device 224 may include a plurality of push buttons on a button panel for operating the wagering game machine 200. In addition, or alternatively, the player input device 224 can comprise a touch screen mounted to the primary display 214 and/or secondary display 216. In one aspect, the touch screen is matched to a display screen having one or more selectable touch keys 230 selectable by a user's touching of the associated area of the screen using a finger or a tool, such as a stylus pointer. A player enables a desired function either by touching the touch screen at an appropriate touch key 230 or by pressing an appropriate push button on the button panel. The touch keys 230 can be used to implement the same functions as push buttons. Alternatively, the push buttons 226 can provide inputs for one aspect of the operating the game, while the touch keys 230 can allow for input needed for another aspect of the game. The various components of the wagering game machine 200 can be connected directly to, or contained within, the casing 212, as seen in FIG. 2, or can be located outside the casing 212 and connected to the casing 212 via a variety of wired (tethered) or wireless connection methods. Thus, the wagering game machine 200 can comprise a single unit or a plurality of interconnected (e.g., wireless connections) parts which can be arranged to suit a player's preferences.

The operation of the basic wagering game on the wagering game machine 200 is displayed to the player on the primary display 214. The primary display 214 can also display a bonus game associated with the basic wagering game. The primary display 214 preferably takes the form of a high resolution LCD, a plasma display, an LED, or any other type of display suitable for use in the wagering game machine 200. The size of the primary display 214 can vary from, for example, about a 2-3″ display to a 15″ or 17″ display. In at least some embodiments, the primary display 214 is a 7″-10″ display. In one embodiment, the size of the primary display can be increased. Optionally, coatings or removable films or sheets can be applied to the display to provide desired characteristics (e.g., anti-scratch, anti-glare, bacterially-resistant and anti-microbial films, etc.). In at least some embodiments, the primary display 214 and/or secondary display 216 can have a 16:9 aspect ratio or other aspect ratio (e.g., 4:3). The primary display 214 and/or secondary display 216 can also each have different resolutions, different color schemes, and different aspect ratios.

A player typically begins play of the basic wagering game on the wagering game machine 200 by making a wager (e.g., via the value input device 218 or an assignment of credits stored on the portable wagering game machine 200 via the touch screen keys 230, player input device 224, or buttons 226) on the wagering game machine 200. In some embodiments, the basic game can comprise a plurality of symbols arranged in an array, and includes at least one payline 232 that indicates one or more outcomes of the basic game. Such outcomes can be randomly selected in response to the wagering input by the player. At least one of the plurality of randomly selected outcomes can be a start-bonus outcome, which can include any variations of symbols or symbol combinations triggering a bonus game.

In some embodiments, the player-accessible value input device 218 of the wagering game machine 200 can double as a player information reader 252 that allows for identification of a player by reading a card with information indicating the player's identity (e.g., reading a player's credit card, player ID card, smart card, etc.). The player information reader 252 can alternatively or also comprise a bar code scanner, RFID transceiver or computer readable storage medium interface. In one embodiment, the player information reader 252 comprises a biometric sensing device.

In some embodiments, a portable wagering game machine 200 can part of a portable wireless communication device, such as a personal digital assistant (PDA), a laptop or portable computer with wireless communication capability, a web tablet, a wireless telephone, a wireless headset, a pager, an instant messaging device, a digital camera, a television, or other device that can receive and/or transmit information wirelessly.

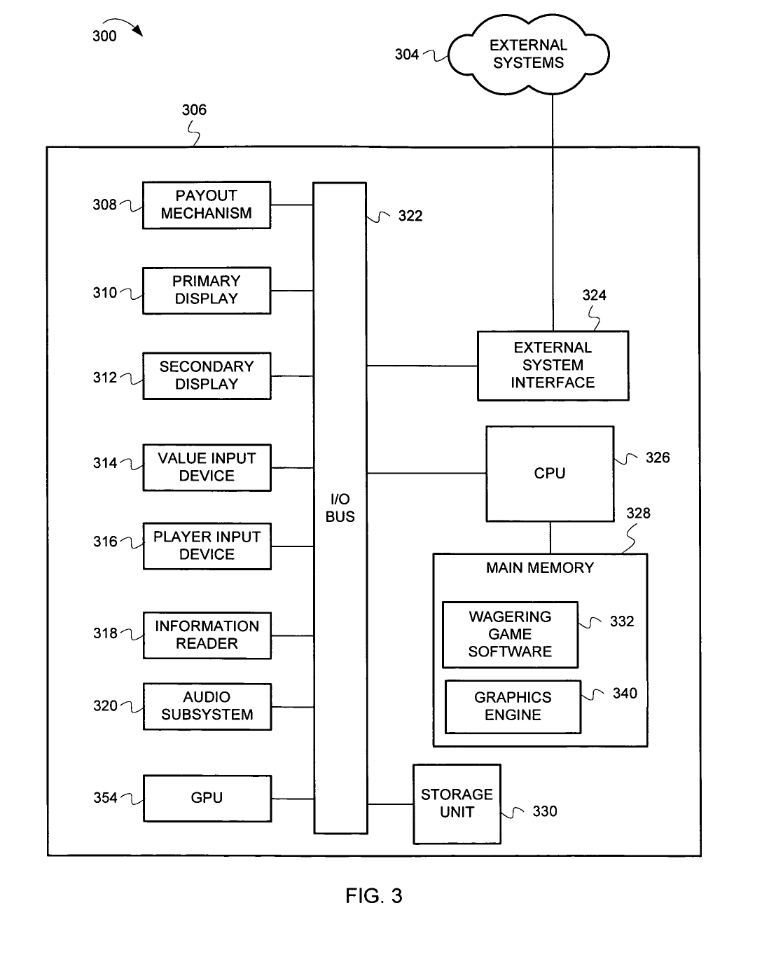

FIG. 3 is a block diagram illustrating a wagering game machine architecture 300, including a control system, according to example embodiments of the invention. As shown in FIG. 3, the wagering game machine 306 includes a central processing unit (processor) 326 connected to main memory 328, which may store wagering game software 332. In one embodiment, the wagering game software can include software associated with presenting wagering games, such as video poker, video black jack, video slots, video lottery, etc., in whole or part. In addition, wagering game software 332 may include bonus rounds, themes, advertising content, attract mode content, pay tables, denomination tables, audio files, video files, operating system files and other software associated with a wagering game or the operation of a wagering game machine.

The processor 326 is also connected to an input/output (I/O) bus 322, which facilitates communication between the wagering game machine's components. The I/O bus 322 may be connected to a payout mechanism 308, graphics processing unit 354, primary display 310, secondary display 312, value input device 314, player input device 316, information reader 318, and/or storage unit 330. The player input device 316 can include the value input device 314 to the extent the player input device 316 is used to place wagers. The I/O bus 322 may also be connected to an external system interface 324, which is connected to external systems 304 (e.g., wagering game networks).

In general, graphics processing unit 354 processes three-dimensional graphics data and may be included as part of primary display 310 and/or secondary display 312. Graphics processing unit 354 includes components that may be used to provide a real-time three-dimensional rendering of a three-dimensional space based on input data. Graphics processing unit 354 may be implemented in software, hardware, or a combination of software and hardware.

In some embodiments, graphics processing unit 354 provides a set of one or more components that provide real-time three dimensional computer graphics for a wagering game application or other software running on a wagering game machine. Graphics processing unit 354 may also be referred to as a game engine. In some embodiments, graphics processing unit 354 provides an underlying set of technologies in an operating system independent manner such that a wagering game may be easily adapted to run on multiple platforms, including various hardware platforms such as stand-alone and portable wagering game machines and various software platforms such as Linux, UNIX, Mac OS X and Microsoft Windows families of operating systems. In some embodiments, graphics processing unit 354 may include various combinations of one or more components such as a rendering engine (“renderer”) for two dimensional or three dimensional graphics, a physics engine and/or components providing collision detection, sound, scripting, animation, artificial intelligence, networking, and scene graphs. A scene graph is generally considered to be an object-oriented representation of a three dimensional game world and is designed for efficient rendering of vast virtual worlds. Thus in various embodiments, a real-time rendering of a three-dimensional model such as a scene graph is provided for a wagering game application or other software operating on a wagering game machine.

The components described above may be implemented in various combinations of software, hardware and/or firmware. Further, while shown as part of a control system 300 for a wagering game machine, graphics processing unit 354 or portions thereof may reside on systems external to the wagering game machine, such as on a game server.

In some embodiments, the components of graphics processing unit 354 may be replaced or extended with more specialized components. For example, in particular embodiments, graphics processing unit 354 may be provided as a series of loosely connected components that can be selectively combined to create a custom graphics engine for a wagering game application.

As noted above, various components may be present or associated with a graphics processing unit 354. For example, a graphics engine 340 may be provided for use with graphics processing unit 354. Various graphics engines are known in the art and may be used in various embodiments of the invention. In some embodiments, the graphics engine comprises a RenderWare graphics engine, available from Criterion Software. Some graphics engines 340 provide real-time 3D rendering capabilities while other components outside of the graphics engine provide other functionality used by wagering games. These types of graphics engines 340 may be referred to as a “rendering engine,” or “3D engine”.

In some embodiments, the graphics processing unit 354 and/or graphics engine 340 may utilize and be designed substantially in accordance with various versions of a graphics API such as Direct3D or OpenGL which provides a software abstraction of a graphics processing unit or video card. Further, in some embodiments, low-level libraries such as DirectX, SDL (Simple DirectMedia Layer), and OpenAL may also be used in presenting a wagering game in order to assist in providing hardware-independent access to other computer hardware such as input devices (mouse, keyboard, and joystick), network cards, and sound cards.

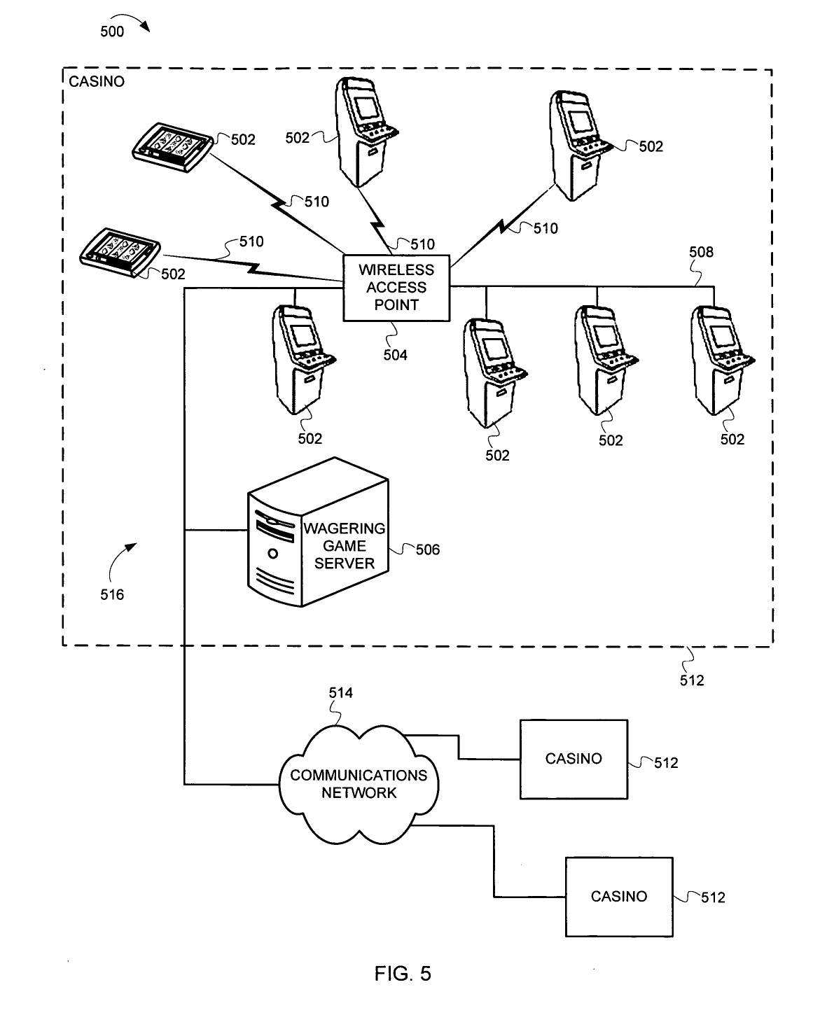

Wagering game software 332 may be loaded from storage unit 330, or it may be loaded from external systems 304 such as servers of other systems on a wagering game network (as illustrated in FIG. 5). In general, wagering game software 332 comprises modules or units that operate to present one or more wagering game upon which monetary value may be wagered. During the course of presenting the wagering games, images composed of graphical objects are displayed on primary display 310 and/or secondary display 312. In addition, bonus games, user interface elements, portal interface elements, help text, pay tables and other elements may be displayed. The graphical elements and the graphical objects may represent various wagering game elements such as reels, cards, dice, symbols, animations, etc., and may also represent elements of a bonus round or other ancillary wagering game software component. The graphical objects may be combined in various manners to create images and sub-images. The images and sub-images for the wagering game elements and other graphical elements may be arranged, sized and dynamically scaled according to user preferences as described below in response to the execution environment and/or in response to events occurring during a wagering game.

Some embodiments of the invention include an audio subsystem 320. Audio subsystem 320 provides audio capabilities to the wagering game machine and may comprise an audio amplifier coupled to speakers or an audio jack, and may further include an audio programming source on a memory such as a CD, DVD, flash memory etc.

In one embodiment, the wagering game machine 306 can include additional peripheral devices and/or more than one of each component shown in FIG. 3. For example, the peripherals may include a bill validator, a printer, a coin hopper, a button panel, or any of the many peripherals now found in wagering game machines or developed in the future. Further, in some embodiments, the wagering game machine 306 can include multiple external system interfaces 324 and multiple processors 326. In one embodiment, any of the components can be integrated or subdivided. Additionally, in one embodiment, the components of the wagering game machine 306 can be interconnected according to any suitable interconnection architecture (e.g., directly connected, hypercube, etc.).

In one embodiment, any of the components of the wagering game machine architecture 300 (e.g., the wagering game presentation unit 332 or portable wagering game management unit) can include hardware, firmware, and/or software for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

In operation, a player may use the portable wagering game machine to activate a play of a wagering game on the machine. Using the available input mechanisms such as value input device 314 or devices coupled through player input device 316, the player may select any variables associated with the wagering game and place his/her wager to purchase a play of the game. In a play of the game, the processor 326 generates at least one random event using a random number generator (RNG) and provides an award to the player for a winning outcome of the random event. Alternatively, the random event may be generated by a remote computer using an RNG or pooling schema and then transmitted to the wagering game machine. The processor 326 operates the displays 310 and 312 to represent the random event(s) and outcome(s) in a visual form that can be understood by the player. In some embodiments, a wagering game segment may be triggered based on certain events. For example, a bonus round may be triggered.

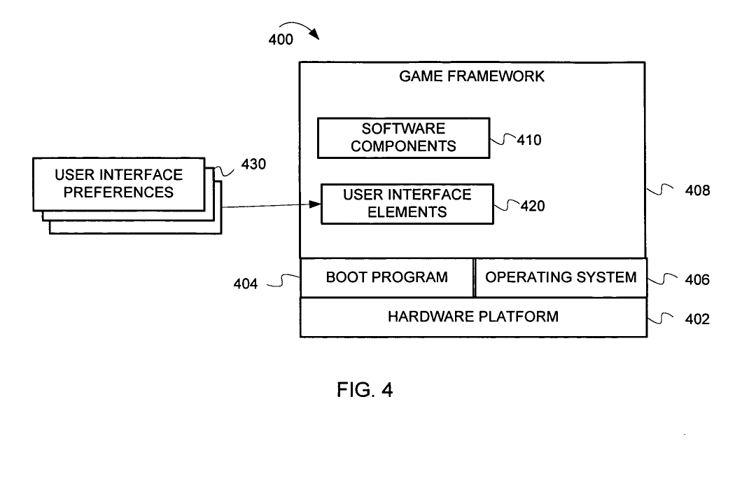

FIG. 4 is a block diagram of a software architecture 400 for a wagering game machine according to an example embodiment. As shown in FIG. 4, the wagering game architecture includes a hardware platform 402, a boot program 404, an operating system 406, and a game framework 408 that includes one or more wagering game software components 410.

In various embodiments, the hardware platform 402 may include a thin-client, thick-client, or some intermediate derivation. The hardware platform 402 may also be configured to provide a virtual client. The boot program 404 may include a basic input/output system (BIOS) or other initialization program that works in conjunction with the operating system 406 to provide a software interface to the hardware platform 402. The game framework 408 may include standardized game software components either independent or in combination with specialized or customized game software components that are designed for a particular wagering game. In one example embodiment, the wagering game software components 410 may include software operative in connection with the hardware platform 402 and operating system 406 to present wagering games, such as video poker, video black jack, video slots, video lottery, etc., in whole or part. According to another example embodiment, the software components 410 may include software operative to accept a wager from a player. According to another example embodiment, one or more of the software components 410 may be provided as part of the operating system 406 or other software used in the wagering game system 400 (e.g., libraries, daemons, common services, etc.).

In addition, the game framework may include one or more user interface elements 420. The user interface elements may include a variety of user interface elements. For example, the user interface elements may include basic wagering game displays, bonus game displays, help displays, pay table displays, graphical user interface element such as buttons, icons, menus etc., and/or portal interfaces. The portal interfaces may include various mechanisms for displaying information regarding a one or more of wagering games, wagering game services or casino services that are available on or through a wagering game machine. The interface provides a mechanism for selecting one of the available wagering games pr services to be presented on the wagering game machine.

The display of the user interface elements described above may be controlled or influenced by user interface preferences 430. The user interface preferences 430 may control the size, aspect ratio, location, scaling input methodology, scaling display methodology and/or portal display operation. In some embodiments, the user preferences may be set or maintained by an individual wagering game machine user such that different wagering game machine users may have different preferences resulting in different displays of the same content. In some embodiments, the preferences 430 may be stored on a player tracking card. In alternative embodiments, the preferences 430 may be stored on a wagering game server (e.g., server 506 of FIG. 5). The preferences to be used on a wagering game machine may be determined using the player tracking information and loaded from the server to the wagering game machine. The preferences may be stored using other mechanisms now known or developed in the future.

Further details on the operation of the software architecture 400 according to embodiments of the invention are provided below.

While FIGS. 1-4 describe example embodiments of a wagering game machine hardware and software architecture, FIG. 5 shows how a plurality of wagering game machines can be connected in a wagering game network.

FIG. 5 is a block diagram illustrating a wagering game network 500, according to example embodiments of the invention. As shown in FIG. 5, the wagering game network 500 includes a plurality of casinos 512 connected to a communications network 514.

Each of the plurality of casinos 512 includes a local area network 516, which may include a wireless access point 504, wagering game machines 502, and a wagering game server 506 that can serve wagering games over the local area network 516. As such, the local area network 516 includes wireless communication links 510 and wired communication links 508. The wired and wireless communication links can employ any suitable connection technology, such as Bluetooth, 802.11, Ethernet, public switched telephone networks, SONET, etc. In one embodiment, the wagering game server 506 can serve wagering games and/or distribute content to devices located in other casinos 512 or at other locations on the communications network 514.

The wagering game machines 502 and wagering game server 506 can include hardware and machine-readable media including instructions for performing the operations described herein.

The wagering game machines 502 described herein can take any suitable form, such as floor standing models, handheld mobile units, bartop models, workstation-type console models, etc. Further, the wagering game machines 502 can be primarily dedicated for use in conducting wagering games, or can include non-dedicated devices, such as mobile phones, personal digital assistants, personal computers, etc. In one embodiment, the wagering game network 500 can include other network devices, such as accounting servers, wide area progressive servers, player tracking servers, and/or other devices suitable for use in connection with embodiments of the invention.

In various embodiments, wagering game machines 502 and wagering game servers 506 work together such that a wagering game machine 502 may be operated as a thin, thick, or intermediate client. For example, one or more elements of game play may be controlled by the wagering game machine 502 (client) or the wagering game server 506 (server). Game play elements may include executable game code, lookup tables, configuration files, game outcome, audio or visual representations of the game, game assets or the like. In a thin-client example, the wagering game server 506 may perform functions such as determining game outcome or managing assets, while the wagering game machine 502 may be used merely to present the graphical representation of such outcome or asset modification to the user (e.g., player). In a thick-client example, game outcome may be determined locally (e.g., at the wagering game machine 502) and then communicated to the wagering game server 506 for recording or managing a player's account. Thus as noted above, a server may store and provide preference information associated with a user to a wagering game machine.

Similarly, functionality not directly related to game play may be controlled by the wagering game machine 502 (client) or the wagering game server 506 (server) in embodiments. For example, power conservation controls that manage a display screen's light intensity may be managed centrally (e.g., by the wagering game server 506) or locally (e.g., by the wagering game machine 502). Other functionality not directly related to game play may include presentation of advertising, software or firmware updates, system quality or security checks, etc.

### Example Wireless Environment

In some embodiments, the wireless access point 504 can be part of a communication station, such as wireless local area network (WLAN) communication station including a Wireless Fidelity (WiFi) communication station, or a WLAN access point (AP). In these embodiments, the wagering game machines 502 can be part of a mobile station, such as WLAN mobile station or a WiFi mobile station.

In some other embodiments, the wireless access point 504 can be part of a broadband wireless access (BWA) network communication station, such as a Worldwide Interoperability for Microwave Access (WiMax) communication station, as the wireless access point 504 can be part of almost any wireless communication device. In these embodiments, the wagering game machines 502 can be part of a BWA network communication station, such as a WiMax communication station.

In some embodiments, any of the wagering game machines 502 can part of a portable wireless communication device, such as a personal digital assistant (PDA), a laptop or portable computer with wireless communication capability, a web tablet, a wireless telephone, a wireless headset, a pager, an instant messaging device, a digital camera, a television, or other device that can receive and/or transmit information wirelessly.

In some embodiments, the wireless access point 504 and the wagering game machines 502 can communicate RF signals in accordance with specific communication standards, such as the Institute of Electrical and Electronics Engineers (IEEE) standards including IEEE 802.11(a), 802.11(b), 802.11(g), 802.11(h) and/or 802.11(n) standards and/or proposed specifications for wireless local area networks, but they can also be suitable to transmit and/or receive communications in accordance with other techniques and standards. In some BWA network embodiments, the wireless access point 504 and the wagering game machines 502 can communicate RF signals in accordance with the IEEE 802.16-2004 and the IEEE 802.16(e) standards for wireless metropolitan area networks (WMANs) including variations and evolutions thereof. However, they can also be suitable to transmit and/or receive communications in accordance with other techniques and standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements—Part 16: “Air Interface for Fixed Broadband Wireless Access Systems,” Can 2005 and related amendments/versions.

In other embodiments, the wireless access point 504 and the wagering game machines 502 can communicate in accordance with a short-range wireless standard, such as the Bluetooth™ short-range digital communication protocol.

It will be appreciated from the above that various components of a wagering game architecture and/or their functionality may be distributed in various manners. For example, all of the components and functionality may reside in a wagering game machine, or various portions may reside in part on a wagering game machine and in part on a server or other network attached device. The scope of the inventive subject matter is meant to include all of these environments.

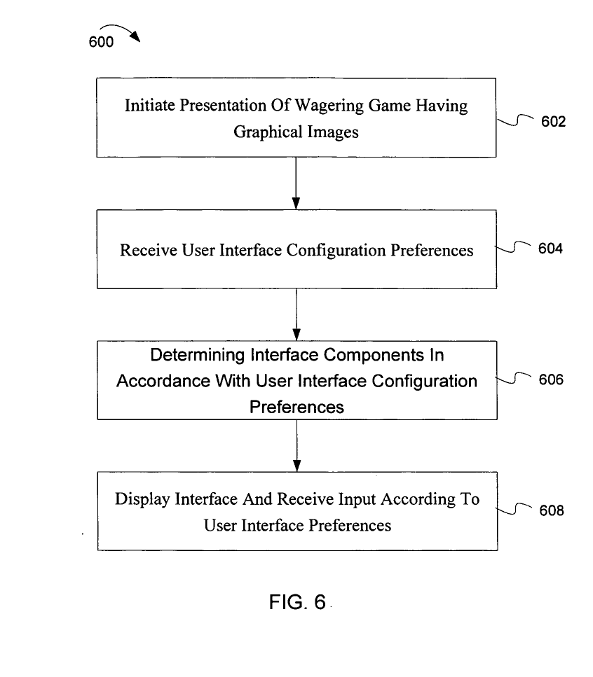

FIG. 6 is a flowchart illustrating a method 600 for providing a wagering game machine with user interface preferences according to example embodiments. The methods to be performed by an operating environment such as control system 300, software architecture 400 and network system 500 constitute computer programs made up of computer-executable instructions. Describing the methods by reference to a flowchart enables one skilled in the art to develop such programs including such instructions to carry out the method on suitable processors for gaming machines (the processor or processors of the computer executing the instructions from computer-readable media). The methods illustrated in FIG. 6 are inclusive of acts that may be taken by an operating environment executing an exemplary embodiment of the invention.

In some embodiments, method 600 begins at block 602 by initiating the presentation of a wagering game upon which monetary value may be wagered. The wagering game may be any type of wagering game such as video versions of a slots, poker, keno, bingo, pachinko, craps or any other type of wagering game. The wagering game may occupy one portion of a display screen. Other display user interface elements may also be presented, including bonus games, live video, pay tables, help text, a wagering game portal interface, and user interface elements (video buttons, icons, menus etc.) may also be displayed on either or both of a primary display and/or a secondary display of a wagering game machine.

At block 604, a system executing the method receives user interface preferences. The user interface preferences may be read from a player tracking card or other player tracking device or they may be read from a server using player tracking information to determine which set of preferences to load from the server. Alternatively, the user may select preferences from an interface provided at a wagering game machine. For example, various options for interface elements may be presented to the user for selection, or various pre-configured preferences may be stored for selection by a user. Further, user preferences may be determined in accordance with a user identification and/or password combination entered by the user.

The preferences may control a variety of characteristics of various elements presented on one or more displays of a wagering game machine. Also, the preferences may control whether an element is to be displayed, and if so how and where it is to be displayed. In some embodiments, these characteristics may include the size, aspect ratio or location of an element. Further, the characteristics may include a scaling input methodology. For example, in some embodiments, the user may select preferences that determine that scaling is performed by dragging a corner of a display element. Alternatively, the user may select a preference that indicates that scaling is performed by simultaneously flicking, or dragging, opposing corners of a display element. The flicking or dragging may be determined using a gesture recognition interface for a touch screen Other scaling input methodologies may be used and are within the scope of the inventive subject matter.

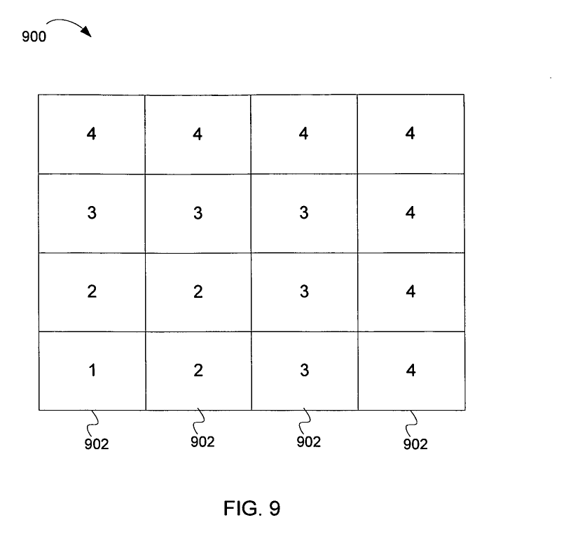

Further, the preferences may control a scaling display methodology. For example, the scaling may be performed as “smooth” scaling in which the display element is dynamically resized such that the elements appears to smoothly increase or decrease in proportion to the scaling factor determined by the scaling input methodology. Alternatively, the scaling display may be performed such that the display elements increases or decreases by fixed increments, as discussed below with reference to FIG. 9.

Still further, the preferences may be used to determine which display various elements are displayed on. For example, one user may prefer to have a basic wagering game to be displayed on a primary display (e.g., displays 114 or 214) and a bonus game to be displayed on a secondary display (e.g., displays 116 or 216). A second user may have preferences that place the same basic wagering game displayed on the secondary display while the bonus game is presented on the primary display. Similarly, help text, pay tables, live video displays and/or portal interfaces may be placed on a primary or secondary display in accordance with user preferences.

At block 606, the system determines the interface characteristics and interface elements present in accordance with the interface preferences received at block 604. In some embodiments, they system may impose limits on the user preference parameters, or on input received in accordance with the parameters. For example, there may be size limitations placed on some or all of the user interface elements in order to prevent them from becoming unreadable or otherwise unusable. Further, the system may modify the preferences in order to prevent interface elements from becoming “orphaned”, that is, placed substantially far away from an associated wagering game element.

At block 608, the system displays the interface elements as determined by block 606.

It should be noted that the user preferences may specify preferences associated with various wagering game events. For example, a user may assign preferences for how elements are sized or located when a win or loss occurs, when a bonus game is entered, when no more credits are available, when entering a community gaming event, when a community jackpot is increased or decreased etc. For example, a “thermometer” indicating how close a jackpot is to threshold may increase in size according to user preferences as the jackpot approaches the hit threshold, thereby giving a user a visual indication of how close the jackpot is to the threshold. The scaling parameters may be controlled by user preferences.

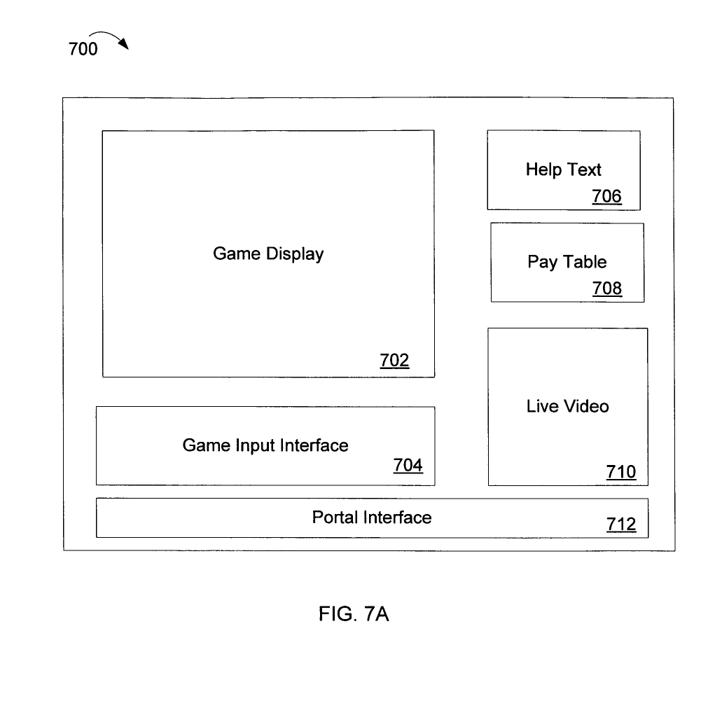

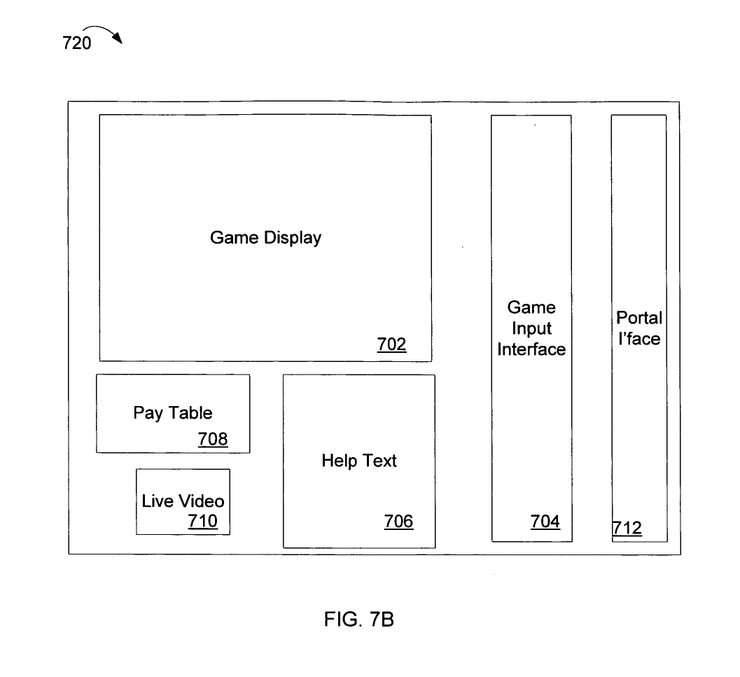

FIGS. 7A and 7B illustrate example interface layouts according to embodiments of the invention. FIG. 7A illustrates a first example interface layout 700. Example interface layout 700 includes wagering game display 702, game input interface 704, help text 706, pay table 708, live video 710 and portal interface 712. Wagering game display 702 comprises the display associated with the output of a wagering game, e.g., the reels, dice, cards etc. that are included in the display of a base wagering game. Game input interface 704 may include video based buttons, icons, menus and other graphical elements used to present input options and to receive input options (e.g., through a touch screen).

Help text 706 may include text or other graphical elements that provide instructional material regarding how to play a wagering game, use interface elements for a wagering game, or other information on the use of a wagering game or wagering game machine. Pay table 708 displays a pay table providing amounts paid for various combinations of symbols, cards, dice etc. that make up the outcome of a wagering game. Live video 710 may be a live video feed of new, weather, sports, entertainment, or other video display. Portal interface 712 provides an interface for selecting one of a plurality of wagering games that may be present on a wagering game machine. It should be noted that the elements described above are just one example of the elements that may be included, located, and sized according to user preferences. Other elements may be included in various embodiments and such elements are within the scope of the inventive subject matter.

FIG. 7B illustrates a second example interface layout 720. The second example may be the result of a different player's preferences being used on the wagering game machine. Alternatively, the second example layout may be the result of a user changing their preferences (e.g., through a user interface provided on the wagering game machine, or through a web service provided to the user on the user's computer. Like example, interface 700, example interface layout 720 includes wagering game display 702, game input interface 704, help text 706, pay table 708, live video 710 and portal interface 712. However, the elements have been repositioned, and resized according to a second set of preferences. For example, the portal interface has been docked along the right side of the display in the second example, rather than along the bottom as presented in the first example. Further, the portal interface 712 has been resized both horizontally and vertically. The other elements 702-710 have also been resized and/or relocated from their positions in example layout 700.

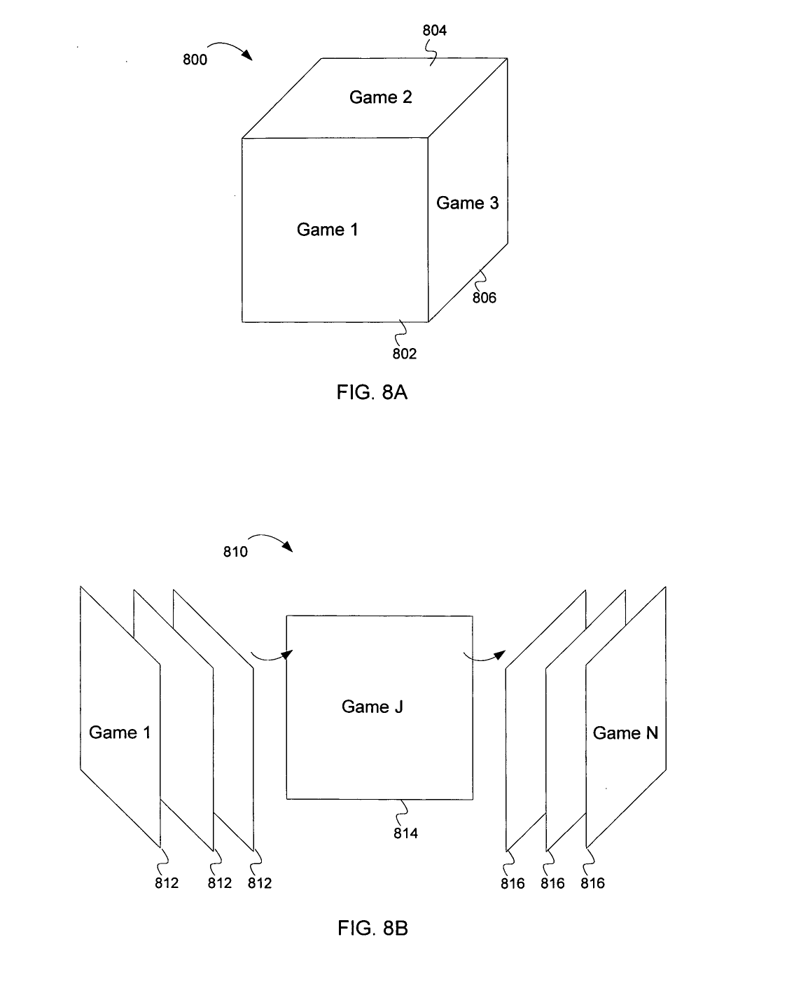

FIGS. 8A and 8B are example three-dimensional portal interfaces according to embodiments of the invention. FIG. 8A illustrates a portal interface that is displayed on a wagering game display as a cube 800. Each face of the cube 800 may present a still or animated image associated with a different wagering game. A user may use a user interface to select a face of the cube 800, thereby causing the wagering game machine to present the selected wagering game. The cube 800 may be rotated about an X, Y or Z axis using a user interface so that other faces of the cube 800 may be exposed for selection.

FIG. 8B illustrates a second example portal interface in which a wagering game flow 810 may be displayed. In the example shown, multiple still or animated images 812, 814 and 816 are associated with different wagering games and may be displayed as a flow of images. Images 812 are associated with wagering games 1 to J−1, image 814 is associated with wagering game J, and images 816 are associated with wagering games J+1 to N, where N is the number of wagering games available through the portal. That is, a user interface may cause the images to flow across the interface, where the image in the middle (e.g., image 814) is currently available for selection. Thus wagering games associated with images 812 to the left of image 814 and images 816 to the right of image 814 are presented in a skewed fashion and not selectable until they are brought to the middle of the flow to face the user. The flow may be controlled using an interface that causes the images to flow either right or left. Flow in a vertical or other direction is also possible and within the scope of the inventive subject matter.

It should be noted that other portal interfaces are possible. For example, a scrolling list of images or available games may be displayed in the portal interface area.

Further, it should be noted that images may be associated with components other than wagering games. For examples, service such as email services, reservation services, hospitality service etc. may be associated with the images 812, 814 or 816.

FIG. 9 illustrates scaling operations of embodiments of the invention. As noted above, scaling operations may be dynamically determined through a user interface. Further, the scaling operation may be smooth, such that the image appears to smoothly increase or decrease in size, or the scaling may occur in fixed steps. FIG. 9 illustrates scaling an image 900 associated with a display element in fixed steps. In the example show, the image for a wagering game element, portal elements, user interface element, help text element, pay table element etc. may be scaled such that the image occupies all of box 1, all of boxes 1 and 2, all of boxes 1 through 3, or all of boxes 1-4. Thus 4 scaling step sizes may be provided in one example embodiment. Other embodiments may provide more or fewer scaling steps. Thus the image, when scaled, appears to jump between the various sizes illustrated in FIG. 9. The user preferences may control the number of steps and/or step increments to use when scaling an graphical image. Further, different elements may be scaled using different scaling display methodologies. For example, some elements may user smooth scaling display, while other elements may be scaled using tiled or incremental scaling.

### CONCLUSION

Systems and methods for presenting a wagering game in which user interface elements may be displayed in accordance with user preferences have been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the inventive subject matter.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

1. A method comprising:
presenting by at least one or more processors a wagering game upon which monetary value may be wagered;
receiving a set of one or more user preferences for presenting a user interface, the preferences including a specification of a location for one or more user interface elements on one or more displays;
determining interface characteristics for the wagering game and the one or more user interface elements in accordance with the user preferences; and
displaying the wagering game and the user interface elements in accordance with the interface characteristics on the one or more displays.

2. The method of claim 1, wherein the user preferences further include one or more of an aspect ratio, scaling input methodology, scaling display methodology, or portal display operation.

3. The method of claim 2, wherein the scaling input methodology includes receiving an indication through a touch screen interface that opposing corners of a display element have been selected and dragged.

4. The method of claim 2, wherein the scaling display methodology includes increasing the size of one or more of the user interface elements in fixed increments, where the fixed increments are determined in accordance with the user preferences.

5. The method of claim 2, wherein the portal display operation includes a game flow display operation comprising displaying a plurality of images, each image representing an available wagering game.

6. The method of claim 2, wherein the portal display operation includes displaying available wagering games on the faces of a cube.

7. The method of claim 6, wherein the cube may be rotated about at least one axis.

8. The method of claim 1, wherein the user preferences are stored on a wagering game server.

9. The method of claim 1, wherein the user preferences are stored on a player tracking card.

10. The method of claim 1, wherein determining interface characteristics for the wagering game or one or more user interface elements includes using a wagering game event and user preferences associated with the wagering game event.

11. A computer-readable storage medium having stored thereon computer-executable instructions to cause one or more processors to perform a method, the method comprising:
presenting a wagering game upon which monetary value may be wagered;
receiving a set of one or more user preferences for presenting a user interface, the preferences including a specification of a location for one or more user interface elements on one or more displays;
determining interface characteristics for the wagering game and the one or more user interface elements in accordance with the user preferences; and
displaying the wagering game and the user interface elements in accordance with the interface characteristics on the one or more displays.

12. The computer-readable storage medium of claim 11, wherein the user preferences further include one or more of an aspect ratio, scaling input methodology, scaling display methodology, or portal display operation.

13. The computer-readable storage medium of claim 12, wherein the scaling display methodology includes increasing the size of one or more of the user interface elements in fixed increments, where the fixed increments are determined in accordance with the user preferences.

14. The computer-readable storage medium of claim 12, wherein the portal display operation includes a game flow display operation comprising displaying a plurality of images, each image representing an available wagering game.

15. The computer-readable storage medium of claim 12, wherein the portal display operation includes displaying available wagering games on the faces of a cube.

16. The computer-readable storage medium of claim 11, wherein determining interface characteristics for the wagering game or one or more user interface elements includes using a wagering game event and user preferences associated with the wagering game event.

17. An apparatus comprising:
a set of one or more preferences associated with a user; and
a processor operable to present a wagering game upon which monetary value may be wagered, wherein the processor is operable to:
receive a set of one or more user preferences for presenting a user interface, the preferences including a specification of a location for one or more user interface elements on one or more displays,
determine interface characteristics for the wagering game and the one or more user interface elements in accordance with the user preferences, and
display the wagering game and the user interface elements in accordance with the interface characteristics on the one or more displays.

18. The apparatus of claim 17, wherein the user preferences further include one or more of an aspect ratio, scaling input methodology, scaling display methodology, or portal display operation.

19. The apparatus of claim 17, further comprising a card reader operable to read a player tracking card, and wherein the player tracking card is operable to store the user preferences.

20. The apparatus of claim 17, further comprising a server operable to store the user preferences.

21. The apparatus of claim 17, further comprising a graphics processing unit operable to present a three-dimensional view of an interface element.

22. The apparatus of claim 21, wherein the graphics processing unit renders a portal interface including a cube based interface or a wagering game flow based interface, the cube based interface and the wagering game flow based interface to display a plurality of images, each image representing an available wagering game.

23. The apparatus of claim 17, wherein the processor is operable to determine interface characteristics for the wagering game or one or more user interface elements includes using a wagering game event and user preferences associated with the wagering game event.
